(19) United States
(12) Patent Application Publication
(10) Pub. No.: US 2017/0333772 A1
(43) Pub. Date: Nov. 23, 2017

(54) Basketball Shooting Training Apparatus

(71) Applicant: Eye-Cubed-U LLC, Westport, CT (US)

(72) Inventors: David J. Sussman, Westport, CT (US); Maximillian K. Sussman, Westport, CT (US)

(21) Appl. No.: 15/156,952

(22) Filed: May 17, 2016

(51) Int. Cl. A63B 69/00; A42B 1/06; A42B 1/00; A42B 1/20; G09B 19/00; A42B 1/22

(52) U.S. Cl. CPC A63B 69/0071; G09B 19/0038; A42B 1/22; A42B 1/006; A42B 1/205; A42B 1/062; A63B 2243/0037

(57) ABSTRACT

An apparatus is provided in the form of an article of headwear designed to force the user to shoot with the proper form every time, together with a method for training a basketball player using the headwear. The headwear has three brims projecting from the front, side and top of the headwear. When a person is shooting a basketball while wearing the headwear, the three brims train the person to have the proper shooting form, by keeping the person's hands, elbows and wrists in the proper locations and at the proper angles.

### BACKGROUND OF THE INVENTION

To shoot a jump shot in basketball and be able to consistently make the shot, one needs to have proper form with the proper form for a jump shot is determined by elbow placement, wrist placement and ball placement. Training athletes to correctly place their elbow, wrist and the ball throughout the process of the jump shot is a challenging process. While repetition and practice shooting a basketball can aid in developing the proper form, it is only effective if the shooter is repeating and practicing the proper form. If the shooter is repeating improper form, he or she will be reinforcing improper technique.

The present invention aims to address the challenge in getting athletes to maintain the proper form throughout the jump shot in the art.

### SUMMARY OF THE INVENTION

The present invention relates to an apparatus in the form of an article of headwear designed to force the user to shoot with the proper form every time. The headwear has three brims that, when one is shooting a basketball while wearing it, keep one's hands from going in the improper positions, one's elbow in the proper angle and one's wrist in the perfect location. If the shooter is not using proper form during a shot, then one or more of the brims will impede the shot.

There is a forward facing brim on the hat to prevent someone from shooting the ball with the hands too close to the forehead. It forces the shooter to lift the hands up high and keep them at the proper angle (perfectly and directly above the elbow) away from one's forehead.

There is an upward facing brim on the hat to prevent someone from shooting the ball with the hands too close to the top of the his or her head. It forces the shooter to use the wrist to shoot the ball rather than the arm. In addition, the position required to shoot the ball while wearing the hat keeps the shooter's elbow and wrist in line to create a perfect ninety-degree angle.

There is a sideways facing brim on the hat to ensure that the shooter keeps the elbow bent at a proper angle and does not bend too much while shooting.

Shooting with the hat creates the perfect shooter's alignment of the ball, wrist and elbow to develop the proper basketball shooting form.

According to a first aspect of the invention, an apparatus for training a basketball shooter is provided. The apparatus comprises an article of headwear having three separate brims. A first brim projects from a base of the headwear at a front section of the headwear. A second brim projects from the base of the headwear at a side section of the headwear and is positioned so as to form a substantially right angle with the first brim. A third brim projects vertically from a top section of the headwear, and may form a substantially right angle with the second brim.

According further to an embodiment of the apparatus of the first aspect of the invention, the headwear comprises a body section configured to cover the top of the head of a user wearing said apparatus. The third brim is configured to project from the body section along a central axis of the body section, with the central axis being oriented along a plane substantially bisecting the first brim.

According further to an embodiment of the apparatus of the first aspect of the invention, the headwear further comprises an adjuster positioned in a rear section of the headwear on the base of the headwear, and configured to adjust a circumference of the headwear.

According to a second aspect of the invention, a method for training a basketball shooter to shoot with a proper form is provided. The method comprises providing an article of headwear to a user to be worn by the user, the headwear having three separate brims. A first brim projects from a base of the headwear at a front section of the headwear. A second brim projects from the base of the headwear at a side section of the headwear and positioned so as to form a substantially right angle with the first brim. A third brim projects vertically from the headwear so as to form a substantially right angle with the second brim. The method further comprises repeatedly shooting a basketball by the user wearing the headwear. The first, second and third brims are each configured to block the user from placing the basketball in a particular position during the act of shooting that is inconsistent with the proper form.

According to the second aspect of the invention, the first brim is configured to prevent the user from holding the basketball in front of the user's face by blocking movement of the basketball from one side of the user to in front of the user's face. The second brim is configured to keep the shooting arm of the user bent at a right angle with the hand above the elbow, by blocking movement of the basketball towards a rear section of the headwear. The third brim is configured to keep the hands of the user away from the top of the user's head, when the user's hands are raised above the user's forehead, by blocking movement of the basketball towards the top of the user's head.

### BRIEF DESCRIPTION OF THE FIGURES

FIG. 1 shows a first, front view of the training apparatus according to an embodiment of the present invention;

FIG. 2 shows a first side view of the training apparatus according to an embodiment of the present invention;

FIG. 3 shows a rear view of the training apparatus according to an embodiment of the present invention;

FIG. 4 shows a second side view of the training apparatus according to an embodiment of the present invention;

FIG. 5 shows a second, front view of the training apparatus according to an embodiment of the present invention;

FIG. 6 shows a front view of a training apparatus according to a further embodiment of the present invention;

FIGS. 7a and 7b show the training apparatus according to an embodiment of the present invention being worn by a user of the apparatus; and

FIGS. 8a, 8b and 8c show the operation of the training apparatus according to an embodiment of the present invention.

### DETAILED DESCRIPTION OF THE FIGURES

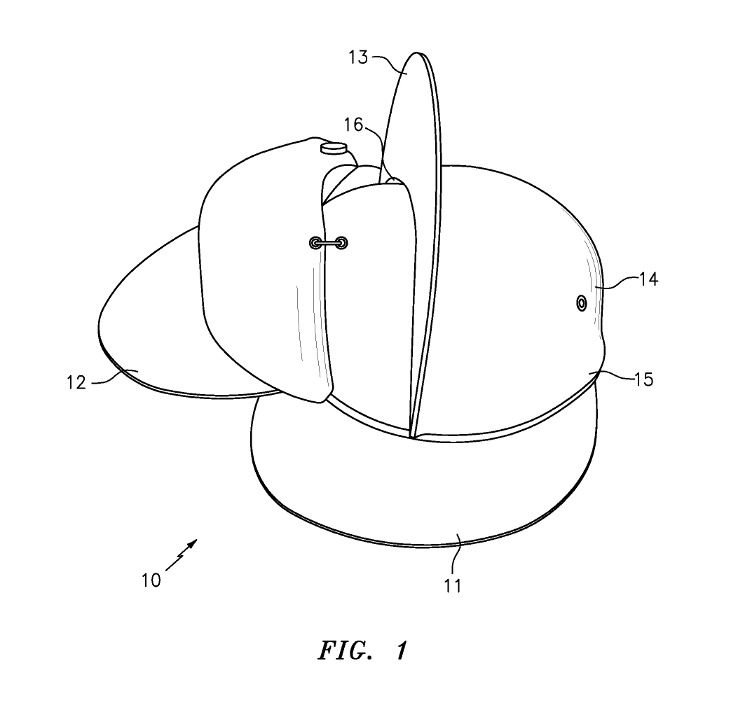

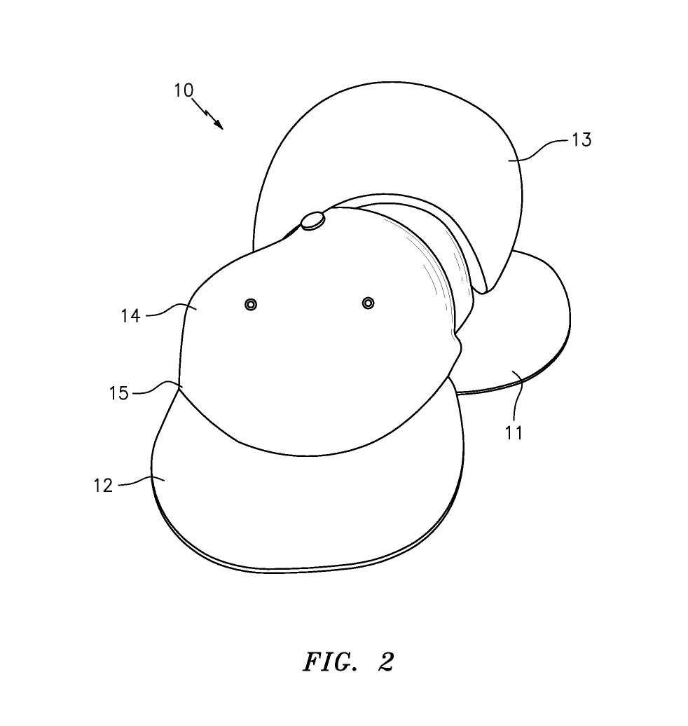

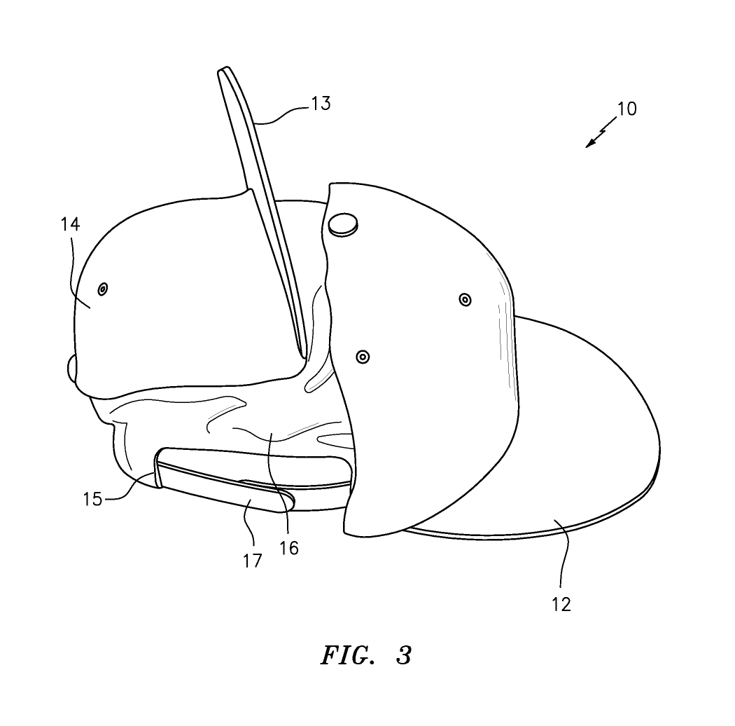

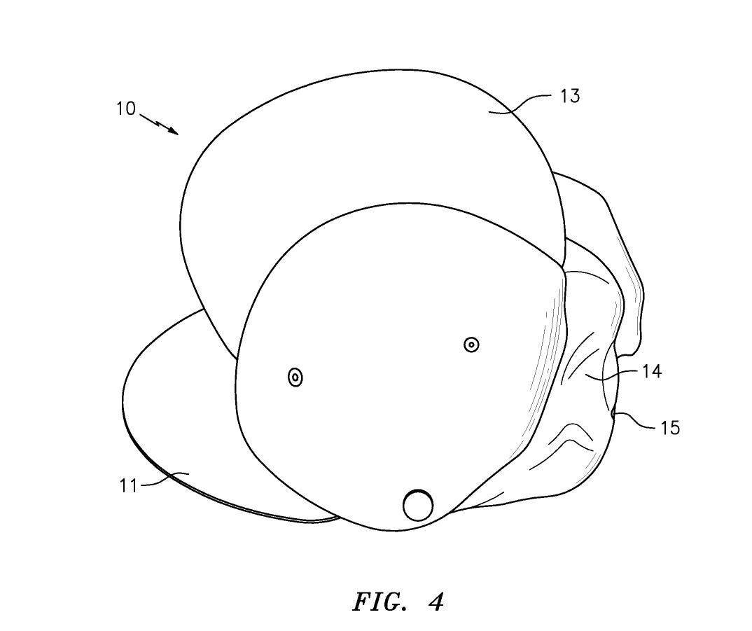

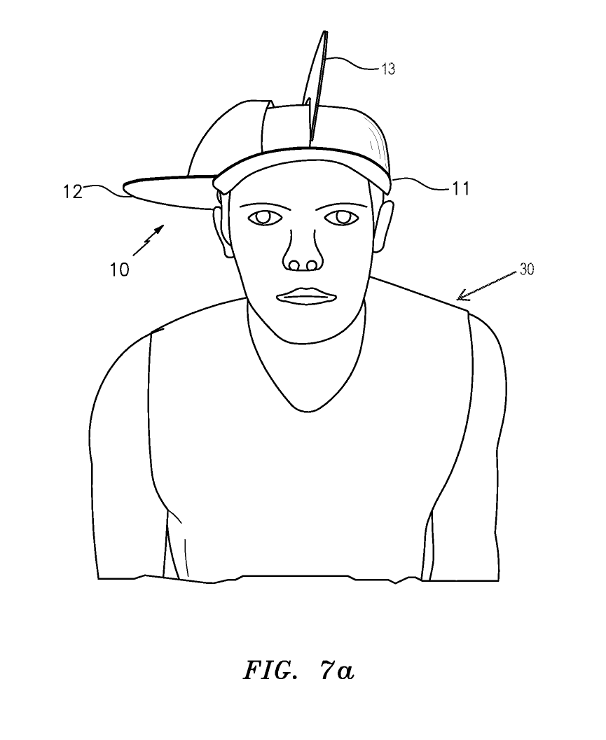

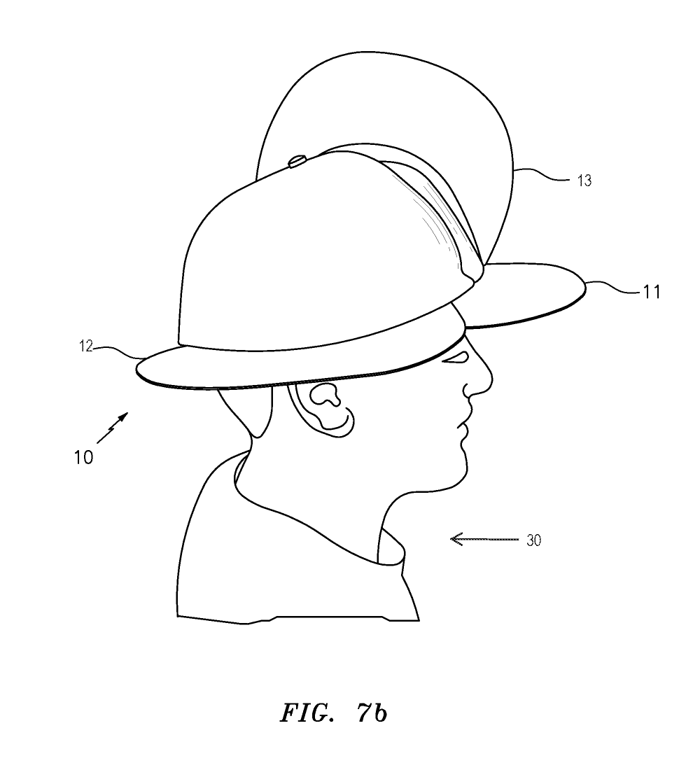

The present invention will now be described with reference made to FIGS. 1-8c.

A basketball shooting training apparatus 10 is provided, in the form of an article of headwear having three brims or bills 11, 12 and 13. In a preferred embodiment shown in the Figures, the headwear of the apparatus 10 is a baseball hat 10 having three separate brims 11, 12 and 13, or a similar type of head covering with three bills 11, 12 and 13.

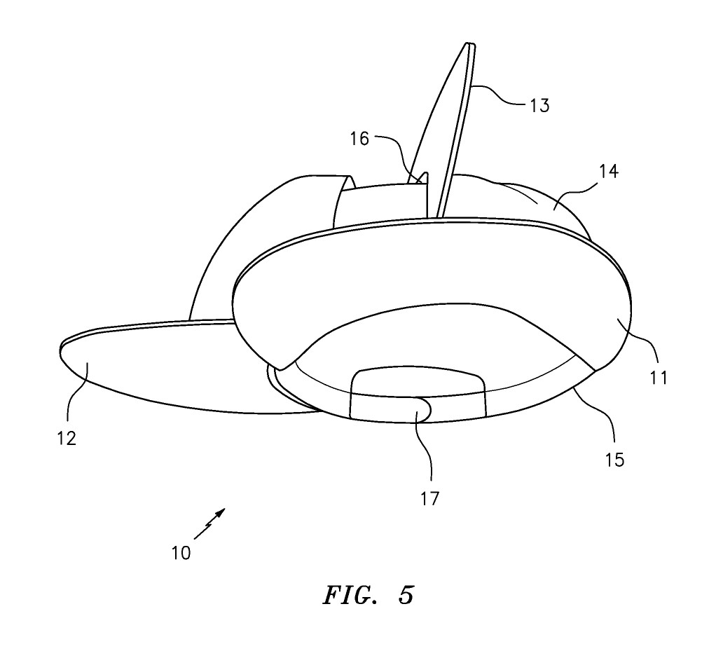

The hat 10 has a body section 14 and a base 15. A first brim 11 projects outwardly from the base 15 in the front of the hat 10. As used herein, terms such as “front” or “rear” are defined relative to the orientation of the hat 10 as it would be worn by a user 30. A second brim 12 projects outwardly from the base 15 on one side of the hat 10. The second brim 12 is oriented so as to be approximately ninety degrees from the first brim 11 in the front of the hat 10. In the embodiments shown in the Figures, the second brim 12 is positioned on the right side of the user 30 and is intended for a right-handed shooter. However, in alternate embodiments, the second brim 12 can be positioned on the user's left side to aid in the training of a left-handed basketball player. A third brim 13 is provided on the hat 10 that projects vertically from a central axis 16 of the top portion of the hat 10. When the hat 10 is worn by a user 30, the third brim 13 and central axis 16 are substantially aligned with the user's midline. In an embodiment of the hat 10 that includes a body section 14 comprised of six panels, as commonly seen in baseball hats, the central axis 16 corresponds substantially to the panel seams that run through the center and button of the hat 10. An angle of approximately ninety degrees is formed between the second and third brims 12 and 13, as shown for Example in FIGS. 1 and 5.

Each of the three brims 11, 12 and 13 are configured to prevent the wearer 30 from developing a particular improper technique in the act of shooting a basketball 20. The three brims 11, 12 and 13 collectively are configured to train the wearer 30 of the hat 10 to shoot a basketball 20 with proper form with respect to the placement and motion of the wearer's hand and elbow.

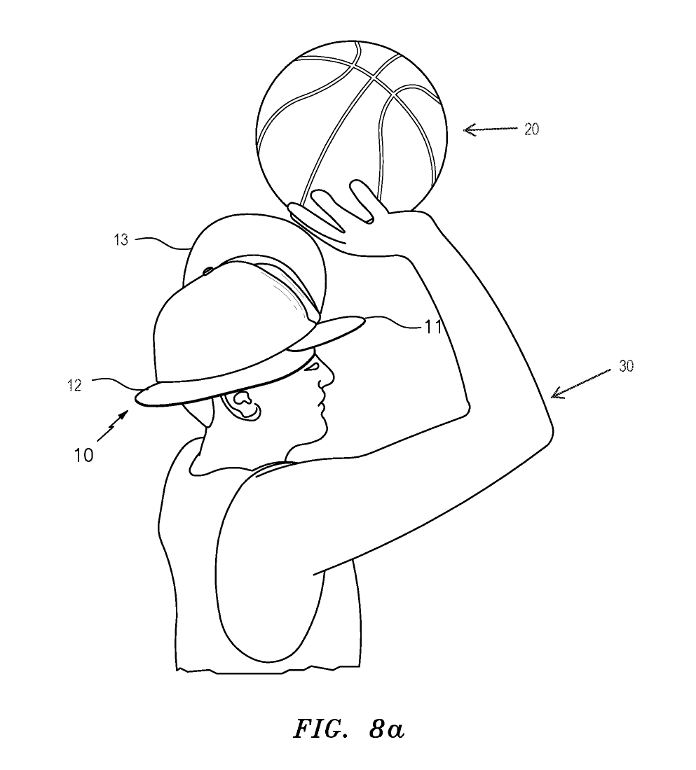

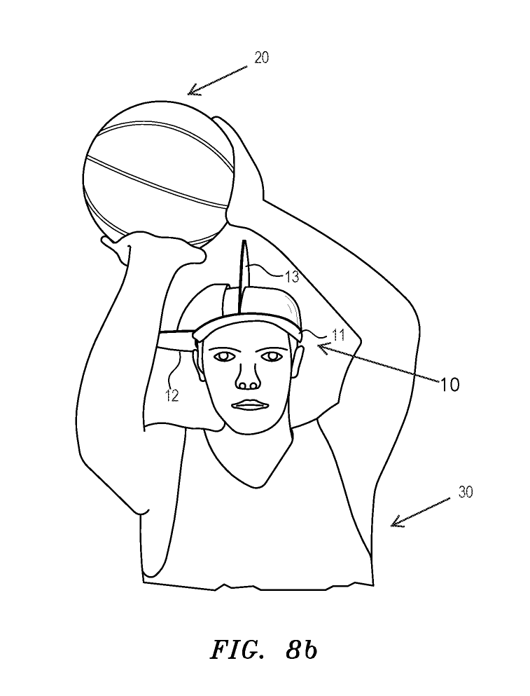

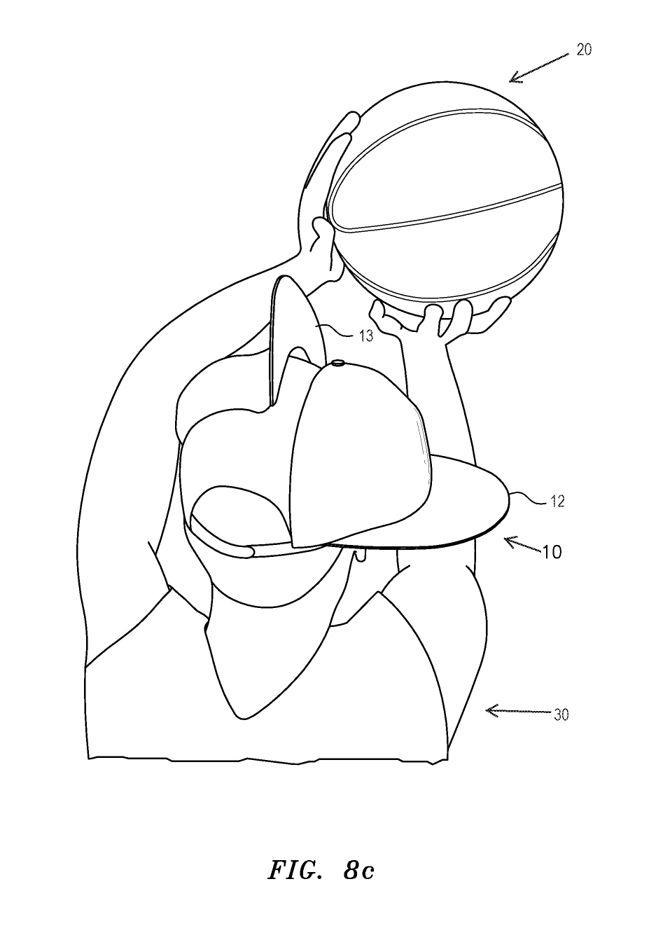

A first aspect of proper form in shooting a basketball 20 is for the shooter 30 to keep his or her hands a sufficient distance from the face during the shot. If the shooter 30 is right-handed, for example, his or her hands should be offset to the right of the forehead, and not directly in front of the forehead. This proper hand placement can be seen, for example, in FIG. 8b. The hat 10 according to the invention trains the shooter 30 into keeping his or her hands in this position by preventing the shooter 30 from placing his or her hands in front of the face or forehead. If the shooter 30 moves his or her hands too close to his or her face, when the ball 20 is raised in the act of shooting, the ball 20 will hit the first brim 11 of the hat 10, preventing the shooter 30 from taking a shot. The hat 10 therefore requires the shooter 30 to move his or her hands to the proper position, as shown in FIGS. 8a-8c, so that the shot can be completed.

A second aspect of proper form in shooting a basketball relates to the placement of the shooter's elbow. When the shooter 30 has the ball 20 raised above the shoulders to shoot, the arm of the shooter's dominant hand (e.g., the right arm of a right-handed shooter) is preferably bent such that the shooter's forearm and hand holding the basketball 20 are substantially above the shooter's elbow, as shown in FIG. 8a, for example. The second brim 12 of the hat 10 forces the shooter 30 into this proper elbow position relative to the shooter's hand. If the shooter's forearm bends too far backwards by moving the dominant hand holding the ball 20 backward, the second brim 12 will obstruct the shooter's motion. This motion by the shooter 30 will cause the ball 20 to hit the second brim 12 of the hat 10, preventing the shooter 30 from taking a shot. The hat 10 therefore teaches the shooter 30 to keep his or her arm bent at the preferred ninety degree angle, as shown in FIG. 8a, so that the shot can be completed.

A third aspect of proper form in shooting a basketball relates to the placement of the shooter's hands through the shooting motion, as he or she is pushing the ball 20 forward and releasing the ball 20. During the act of shooting, the shooter's hands should remain substantially above the elbow of the dominant arm, as described previously and shown for example in FIG. 8a. The proper hand placement does not solely require the proper arm-bend, but also requires the hands remain above the elbow without drifting inwards, toward the shooter's center. The third brim 13 is configured to keep the shooter's hands above and aligned with the elbow, as shown for example in FIG. 8b, and prevent the shooter's hands from moving toward the top of his or her head and the center of the body. If the shooter's arm moves too far back or towards his or her center once the ball 20 is raised above his or her head, the ball 20 will hit the third brim 13, and prevent the shooter 30 from completing the shooting motion. Thus, the third brim 13 keeps the shooter's hand above the elbow while the shooter is continuing the shooting motion. This further aids the shooter 30 in forcing him or her to use his or her wrist (of the dominant hand) to shoot the ball 20, consistent with the proper shooting form, rather than using his or her dominant arm to push the ball 20.

Each of the three brims 11, 12 and 13 acts in combination so that the proper shooting form is maintained throughout the shooting motion from start to finish. By wearing the hat 10 while practicing shooting, the shooter 30 is able to train themselves into keeping his or her hands, elbow and wrist in the correct placement. The brims 11, 12 and 13 of the hat 10 force the user into proper form for shooting, which is then learned to repetition so that the user can later shoot with the proper form while playing basketball 20 without wearing the hat 10.

The hat 10 may further include an adjuster 17, to adjust the size of the hat 10. The adjuster 17 is positioned in the rear of the hat 10 along the base 15, and can be in the form of any adjuster 17 known in the art of hats, including but not limited to straps containing corresponding snaps and openings, hook-and-loop fasteners, buckles, and the like. In further embodiments, the hat 10 may omit an adjuster 17, and be formed in different sizes that are non-adjustable, and selected by the user to fit his or her specific size.

The body section 14 of the hat 10 can be made from any number of materials, including for example, wool, cotton or a blend of cotton and a synthetic material, such as polyester. The brims 11, 12 and 13 are preferably made from a harder material, such as a plastic material or buckram, and can be wrapped in the same material used to form the body section 14 of the hat 10, in order to provide a consistent appearance in the hat 10. The hat 10 can comprise design and/or text elements on one or more parts of the hat 10, including the brims 11, 12 or 13 and the body section 14.

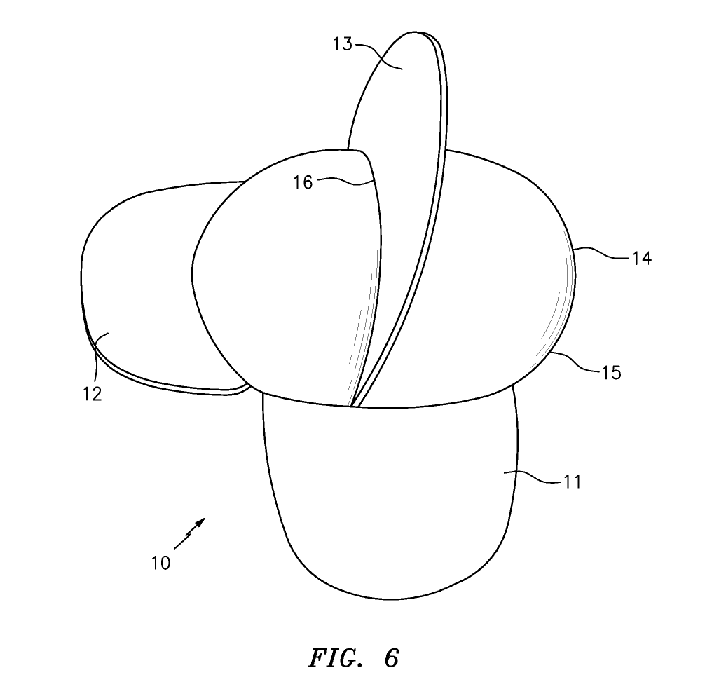

The hat 10 according to the invention can be manufactured in accordance with a number of methods without departing from the scope of the invention. For example, in a first embodiment for making the hat 10 according to the invention, a body section 14 can be assembled from a plurality of panels (such as five or six panels) affixed to each other by panel seams, as typically found in baseball caps. During this assembly, the third brim 13 may be seamed onto what becomes the body section 14 along a central axis 16 formed by the panels. An interior band may also be provided around the circumference of the base 15 of the body section 14, which is attached to the body section 14, and further secures the panels together. A first brim 11 is attached to the base 15, in what becomes the front section of the hat 10, and a second brim 12 is attached to the base 15, substantially ninety degrees from the first brim 11. Alternatively, the first brim 11 and second brim 12 can be provided as an integral unit including the two brims separated by substantially ninety degrees, which can then be attached to the base 15 in a single step. An embodiment of the hat 10 having three brims 11, 12 and 13 attached to the same body section 14 of a single hat is shown in FIG. 6.

According to an alternate method for manufacturing the hat 10 according to the present invention, the hat 10 can be made from three separate pre-assembled, standard baseball hats, as shown for example in FIGS. 1-5. A first baseball hat is provided and its body section opened and expanded to be semispherical. The brim of the first baseball hat can serve as the first brim 11 in the front of the hat 10. The body section of a second hat is folded inward (i.e., the rear section of the hat folded towards the front section where the brim is located) so as to form a quarter-sphere with its brim projecting from the front. The second hat can be placed onto the top surface of the first hat and oriented such that the surface of the body of the first hat fits into the quarter-sphere formed in the second hat and the two hat brims are separated by approximately ninety degrees. The two hats are then sewn together using any number of methods, and the brim of the second hat forms the second brim 12. The body section of a third hat is similarly folded inward so as to form a quarter-sphere with its brim projecting from the front. The third hat can be placed onto a portion of the top surface of the first hat not covered by the second hat, and oriented such that the surface of the body of the first hat fits into the quarter-sphere formed in the third hat, with the brim of the third hat projecting vertically from the top surface of the first hat, and is aligned down the center of the first hat. The two hats are then sewn together using any number of methods, and the brim of the third hat forms the third brim 13.

According to a further embodiment, the hat may comprise brims that are attachable and detachable. In accordance with this embodiment, a semispherical body of a hat is provided, and the front, top and each of the left and right sides are provided with fastening means, including for example, snaps, hook-and-loop fasteners or buckles. At least three hat brims are also provided, each of which comprises a corresponding fastening means. The fastening means are provided on interior and/or exterior the body of the hat in such positions that allow the placement of the brims in the front, top and side of the hat, as shown in the Figures and described herein. This embodiment of the present invention allows the hat to be adjusted between right-handed and left-handed shooters. The side brim can be attached to the right side of the hat for use by a right-handed shooter, but if the hat is to be used by a left-handed shooter, the side brim can be attached to the left side of the hat. This embodiment of the present invention further allows the user to utilize different combinations of hats and brims with various text and/or design components. The user can mix and match different hats and brims, which may include different designs or customized designs, by attaching and detaching the brims to the body of the hat. Further in accordance with this embodiment, a standard baseball hat can be provided having a front-facing brim sewn to a body section, and with fastening means provided on the top and sides of the body section, for the attachment of separate brims as described herein.

The hat 10 as shown in the Figures can be assembled according to alternative methods, without departing from the scope of the invention.

Although the headwear of the apparatus according to the invention is shown in the Figures as a baseball hat 10 having three brims 11, 12 and 13, the apparatus of the invention can take the form of alternative types of headwear each having three brims attached as described herein, including but not limited to an elastic headband, a hard hat or plastic helmet, or a visor lacking a body section 14 to cover the top of one's head.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

1. An apparatus for training a basketball shooter, comprising:
an article of headwear comprising:
a first brim projecting from and permanently affixed to a base of the headwear at a front section of the headwear;
a second brim projecting from the base of the headwear at a side section of the headwear and positioned so as to form a substantially right angle with the first brim; and
a third brim projecting vertically from and permanently affixed to a top section of the headwear.

2. The apparatus according to claim 1, wherein the headwear comprises a body section configured to cover the top of the head of a user wearing said apparatus.

3. The apparatus according to claim 2, wherein the third brim is configured to project from the body section along a central plane of the body section, the central plane substantially bisecting the first brim.

4. The apparatus according to claim 3, wherein the first brim and the second brim are oriented so as to be substantially planar and wherein the second brim and the third brim form a substantially right angle.

5. The apparatus according to claim 1, wherein the headwear further comprises an adjuster positioned in a rear section of the headwear on the base of the headwear, and configured to adjust a circumference of the headwear.

6. The apparatus according to claim 1, wherein the second brim is configured to be detachable and attachable to either of a right side section or a left side section of the article of headwear.

7. (canceled)

8. A method for improving a shooting form of a basketball shooter, comprising:
providing an article of headwear to a user to be worn by the user, the headwear comprising:
a first brim projecting from and permanently affixed to a base of the headwear at a front section of the headwear;
a second brim projecting from the base of the headwear at a side section of the headwear and positioned so as to form a substantially right angle with the first brim; and
a third brim projecting vertically from and permanently affixed to a top section of the headwear; and
repeatedly shooting a basketball by the user while wearing the headwear;
wherein the first, second and third brims are each configured to limit how the user may move the basketball during the act of shooting by blocking movement of the basketball upon contact with the first, second and third brims.

9. The method according to claim 8, wherein the first brim is configured to prevent the user from holding the basketball within a minimum distance in front of the user's face by blocking movement of the basketball if the basketball is within the minimum distance in front of the user's face, wherein the minimum distance in front of the user's face corresponds to a length of the first brim extending from the base of the front section of the headwear.

10. The method according to claim 8, wherein the second brim is configured to limit a degree of elbow bend in a raised shooting arm of the user by blocking movement of the basketball towards a rear section of the headwear when the raised shooting arm and/or basketball are within a minimum distance from a side of the headwear defined by a length of the second brim extending from the base of the side section of the headwear.

11. The method according to claim 8, wherein the third brim is configured to limit a distance between the hands of the user and the top of the user's head, when the user's hands are raised above the user's forehead, by blocking movement of the basketball if the user's hands approach the top of the user's head when the user's hands and/or the basketball are within a minimum distance from the top of the user's head defined by a length of the third brim extending from the top section of the headwear.

12. The apparatus of claim 1, wherein the second brim is permanently affixed to a left side section or a right side section of the base of the headwear.

13. The method of claim 8, wherein the second brim is permanently affixed to a left side section or a right side section of the base of the headwear.

14. The apparatus of claim 1, wherein the third brim is seamed onto the top section of the headwear to permanently affix the third brim to the top section of the headwear.

15. The method of claim 8, wherein the third brim is seamed onto the top section of the headwear to permanently affix the third brim to the top section of the headwear.

16. The apparatus of claim 1, wherein the first brim is seamed to the base of the headwear at the front section of the headwear to permanently affix the first brim to the front section of the headwear.

17. The method of claim 8, wherein the first brim is seamed to the base of the headwear at the front section of the headwear to permanently affix the first brim to the front section of the headwear.

18. The apparatus of claim 1, wherein the article of headwear comprises three attached baseball hats, comprising:
a first baseball hat comprising a first semispherical body section and the first brim;
a second baseball hat comprising a second body section folded into a quarter-sphere having the second brim projecting therefrom; and
a third baseball hat comprising a third body section folded into a quarter-sphere having the third brim projecting therefrom;
wherein the second baseball hat is positioned on and attached to a top surface of the first baseball hat, such that the first body section of the first baseball hat fits into the quarter-sphere of the second body section of the second baseball hat and the first and second brims are separated by approximately ninety degrees and are substantially planar; and
wherein the third baseball hat is positioned onto and attached to a portion of the top surface of the first hat uncovered by the second baseball hat, such that the first body section of the first baseball hat fits into the quarter-sphere of the third body section of the third baseball hat and the third brim projects vertically from the top surface of the first hat along a central plane substantially bisecting the first brim and wherein the third baseball hat is attached to the first baseball hat.

19. The apparatus of claim 18, wherein the first baseball hat and the second baseball hat are sewn together and the first baseball hat and the third baseball hat are sewn together.

20. The method of claim 8, wherein the third brim is configured to project from the body section along a central plane of the body section, the central plane substantially bisecting the first brim;
wherein the first brim and the second brim are oriented so as to be substantially planar; and
wherein the second brim and the third brim form a substantially right angle

21. The method of claim 20, wherein the first brim is configured to prevent the user from holding the basketball within a minimum distance in front of the user's face by blocking movement of the basketball if the basketball is within the minimum distance in front of the user's face, wherein the minimum distance in front of the user's face corresponds to a length of the first brim extending from the base of the front section of the headwear;
wherein the second brim is configured to limit a degree of elbow bend in a raised shooting arm of the user by blocking movement of the basketball towards a rear section of the headwear when the raised shooting arm and/or basketball are within a minimum distance from a side of the headwear defined by a length of the second brim extending from the base of the side section of the headwear; and
wherein the third brim is configured to limit a distance between the hands of the user and the top of the user's head, when the user's hands are raised above the user's forehead, by blocking movement of the basketball if the user's hands approach the top of the user's head when the user's hands and/or the basketball are within a minimum distance from the top of the user's head defined by a length of the third brim extending from the top section of the headwear.
